(19) United States
(12) Patent Application Publication
(10) Pub. No.: US 2026/0050316 A1
(43) Pub. Date: Feb. 19, 2026

(54) Attention Awareness Detected by Camera

(71) Applicant: Apple Inc., Cupertino, CA (US)

(72) Inventors: Noah D. Bedard, Los Gatos, CA (US); Robert T. Aloe, Campbell, CA (US); Bosheng Zhang, Sunnyvale, CA (US); David C. Mott, Los Altos, CA (US)

(21) Appl. No.: 19/298,560

(22) Filed: Aug. 13, 2025

Related U.S. Application Data
(60) Provisional application No. 63/682,891, filed on Aug. 14, 2024.

(51) Int. Cl. G06F 1/3231; G06F 1/16; G06F 1/3234; G06T 7/70

(52) U.S. Cl. CPC G06F 1/3231; G06F 1/163; G06F 1/1686; G06F 1/1694; G06F 1/3265; G06T 7/70; G06T 2207/20084; G06T 2207/30201

(57) ABSTRACT

This disclosure relates generally to the field of user/device interactions. More particularly, it relates to techniques for detecting when a user's attention is directed at an electronic device, e.g., as determined based, at least in part, on analysis of images captured by one or more cameras integrated in the electronic device. Attention awareness can help to reduce the power and/or computing resources consumed by the electronic device, e.g., by only providing certain user experiences at the electronic device when they are actually likely to be desired by the user. In some embodiments, an attention awareness algorithm may be initiated by some triggering event or action. Once initiated, images captured by a camera of the electronic device may be fed to an attention detection algorithm to determine whether the user's head is in a pose where the algorithm believes that the user likely desires to interact with the device's user interface.

### TECHNICAL FIELD

This disclosure relates generally to the field of user/device interactions. More particularly, but not by way of limitation, it relates to techniques for detecting when a user's attention is directed at an electronic device, e.g., as determined based, at least in part, on analysis of images captured by one or more cameras or other video capture-capable devices integrated in the electronic device.

### BACKGROUND

The advent of portable integrated computing devices has caused a wide proliferation of compact cameras and other video capture-capable devices. These integrated computing devices commonly take the form of smartphones, tablets, wearables (e.g., smart watches), or laptop computers, and typically include general purpose computers, cameras, sophisticated user interfaces including touch-sensitive screens, and wireless communications abilities through Wi-Fi, Bluetooth, LTE, HSDPA, New Radio (NR), and other cellular-based or wireless technologies. The wide proliferation of these integrated devices provides opportunities to use the devices'capabilities to perform tasks that would otherwise require dedicated hardware and software.

For example, portable integrated computing devices, such as smartphones, tablets, wearables, and laptops typically have one or more embedded (i.e., integrated) cameras. These cameras generally amount to lens/camera hardware modules that may be controlled through the use of a general-purpose computer using firmware and/or software (e.g., applications, or “apps”) and a user interface, including touch-screen buttons, fixed buttons, and/or touchless controls, such as gestures or voice control. The integration of cameras into these portable integrated computing devices, such as smartphones, wearables, tablets, and laptop computers, has enabled users to capture and share images and videos in ways never before possible and has allowed users to interact with devices—and for devices to understand their surroundings—in ways never before possible.

### SUMMARY

Devices, methods, and non-transitory computer-readable media (CRM) are disclosed herein to perform user attention detection at an electronic device, e.g., a wearable electronic device, based, at least in part, on a determination of the user's head/gaze pointing direction relative to a display of the electronic device.

For example, a method is disclosed herein, comprising: detecting, at an electronic device (e.g., a wearable electronic device, such as a smartwatch, or the like), a potential attention trigger; obtaining, in response to the detected potential attention trigger, at least a first input image captured at a first time by a camera of the electronic device; performing a first attention detection operation based, at least in part, on the first input image; performing, in response to the first attention detection operation determining that user attention is not detected, a first user interface-related action on the electronic device; and performing, in response to the first attention detection operation determining that user attention is detected, a second user interface-related action on the electronic device.

According to some embodiments, the potential attention trigger comprises detecting at least one of the following: a notification, a device wake status, a user interface touch, or playing media content.

According to other embodiments, the method further comprises: confirming, in response to the detected potential action trigger, that a current pose of the electronic device is within a threshold difference of a predetermined pose. According to some such embodiments, confirming that the current pose of the electronic device is within a threshold difference of a predetermined pose further comprises: obtaining positional data from an inertial measurement unit (IMU) of the electronic device.

According to some embodiments, performing a first attention detection operation on the first input image further comprises: performing a face detection operation on the first input image to identify a face of a user of the electronic device; determining, based on the face detection operation, a current pose of the face of the user relative to the electronic device; and detecting user attention based, at least in part, on applying a pose threshold to the determined current pose of the face of the user.

According to other embodiments, performing a first attention detection operation on the first input image further comprises: performing a face detection operation on the first input image to identify a face of a user of the electronic device; determining, based on the face detection operation, a current gaze direction of the user relative to the electronic device; and detecting user attention based, at least in part, on applying a gaze direction threshold to the determined current gaze direction of the user.

According to still other embodiments, performing a first attention detection operation on the first input image further comprises: performing a face detection operation on the first input image to identify a face of a user of the electronic device; determining, based on the face detection operation, one or more image landmarks in the first input image; and detecting user attention based, at least in part, on applying a machine learning (ML) classifier to the determined one or more image landmarks in the first input image.

According to yet other embodiments, performing a first attention detection operation on the first input image further comprises: detecting user attention directly based, at least in part, on applying a deep neural network (DNN) to the first input image.

According to some embodiments, the first attention detection operation outputs a value, and the first attention detection operation determining that user attention is detected comprises determining that the value output from the first attention detection operation is greater than or equal to an attention threshold value.

According to some embodiments, the first user interface-related action performed on the electronic device comprises at least one of: a display dimming operation, a display deactivation operation, or entering a low-power state.

According to some embodiments, the second user interface-related action performed on the electronic device comprises at least one of: a display screen auto-scrolling operation, a user interface navigation operation, or a user interface selection operation.

According to some embodiments, the method further comprises: performing, in response to a determined time interval elapsing since the performance of the first attention detection operation, a second attention detection operation, wherein the second attention detection operation is based, at least in part, on a second input image captured at a second time by the camera of the electronic device.

According to other embodiments, the method further comprises: ceasing, in response to the second attention detection operation determining that user attention is not detected, performance of the second user interface-related action on the electronic device.

According to some embodiments, the first user interface-related action and the second user interface-related action are different.

Various non-transitory computer-readable media (CRM)

embodiments are also disclosed herein. Such CRM are readable by one or more processors. Instructions may be stored on the CRM for causing the one or more processors to perform any of the embodiments disclosed herein. Various electronic devices (e.g., wearable devices) are also disclosed herein, e.g., comprising memory, one or more processors, one or more image capture devices, displays and/or other electronic components (e.g., IMUs, microphones, ambient light sensors (ALS), etc.), and programmed to perform in accordance with the various method and CRM embodiments disclosed herein.

### BRIEF DESCRIPTION OF THE DRAWINGS

FIG. 1 illustrates an exemplary image of a user captured by an image capture device of a wearable electronic device, according to one or more embodiments.

FIG. 2 illustrates examples of using a user's head/gaze pointing direction relative to a display of a wearable electronic device as a signal indicative of user attention, according to one or more embodiments.

FIG. 3 illustrates additional examples of using a user's head/gaze pointing direction relative to a display of a wearable electronic device as a signal indicative of user attention, according to one or more embodiments.

FIG. 4A is a flow diagram illustrating a method of using a user's head/gaze pointing direction relative to a display of a wearable electronic device as a signal indicative of user attention, according to various embodiments.

FIG. 4B is a flow diagram illustrating exemplary algorithms for detecting user attention relative to a display of a wearable electronic device using images captured by one or more integrated cameras of the electronic device, according to various embodiments.

FIG. 4C is a flow diagram illustrating another method of using a user's head/gaze pointing direction relative to a display of a wearable electronic device as a signal indicative of user attention, according to various embodiments.

FIG. 5 is a block diagram illustrating a programmable electronic computing device, in which one or more of the techniques disclosed herein may be implemented.

### DETAILED DESCRIPTION

In the following description, for purposes of explanation, numerous specific details are set forth in order to provide a thorough understanding of the inventions disclosed herein. It will be apparent, however, to one skilled in the art that the inventions may be practiced without these specific details. In other instances, structure and devices are shown in block diagram form in order to avoid obscuring the inventions. References to numbers without subscripts or suffixes are understood to reference all instance of subscripts and suffixes corresponding to the referenced number. Moreover, the language used in this disclosure has been principally selected for readability and instructional purposes and may not have been selected to delineate or circumscribe the inventive subject matter, and, thus, resort to the claims may be necessary to determine such inventive subject matter. Reference in the specification to “one embodiment” or to “an embodiment” (or similar) means that a particular feature, structure, or characteristic described in connection with the embodiments is included in at least one embodiment of one of the inventions, and multiple references to “one embodiment” or “an embodiment” should not be understood as necessarily all referring to the same embodiment.

With the rise in availability of compact digital cameras in personal electronic devices has come a rise in the need for more complex processing of the data captured by such electronic devices, including the performance of user interface-related and/or environmental understanding-based tasks. In particular, such electronic devices may want to predict or determine the types of interactions that a user wishes to take with the electronic device (and/or if a user currently wishes to interact with the electronic device at all), e.g., based on an analysis of the images in video image streams captured by a camera(s) of the electronic device. Such analysis may comprise the performance of: face detection (FD) algorithms, image understanding tasks, machine learning (ML)-based algorithms and models, three-dimensional (3D) scene understanding tasks, and/or 3D object understanding tasks on the captured images.

However, there remains an additional need for the ability to perform such user/device interaction tasks (and/or other types of tasks) with greater efficiency—and while leveraging information streams gathered by multiple types of input modalities (e.g., not solely captured video image stream data, but also the possibility of captured inertial measurement unit (IMU) data, microphone data, ALS data, individual still images, or the like).

Performance of such user/device interaction tasks are desirably able to leverage a user's head/gaze pointing direction, e.g., as determined from images captured by one or more integrated device cameras, to determine whether (and when) the user is paying attention to a display of the electronic device. Note: As used herein, the terms head pointing direction and gaze pointing direction may refer to two different signals (e.g., it is possible for a user's head to rotate to the left, while the gaze is not changing or even rotating to right), either one of which (or both) may be used as a proxy signal for estimating a direction of a user's attention, based on the needs and/or capabilities of a given implementation. Attention awareness can help to reduce the power and/or computing resources consumed by the electronic device, e.g., by only providing certain user experiences (UX) at the electronic device when such experiences are actually likely to be desired by the user.

In some embodiments, as will be described herein, an attention awareness algorithm may be initiated by some triggering event or action, e.g., a wake notification (such as an alert or timer), a display screen tap or other device UI button (e.g., physical or virtual button) interaction, moving the device into a particular pose, or showing audio playback controls on the device's display, etc. Once triggered, the device may use an IMU as a first pass to see if the device is also currently within a threshold range of a predetermined “attention-indicative” device pose (e.g., position and/or orientation), i.e., a device pose in which the user might wish to interact with the device's display (or other UI elements). Once the attention awareness algorithm is initiated, images captured by a camera(s) of the electronic device may be fed to the attention detection algorithm (e.g., at regular or irregular intervals) to determine whether the user's head and/or gaze is (or remains) pointing in a direction wherein the attention awareness algorithm believes that the user likely desires to interact with the device's user interface.

If user attention is not detected, the device's display can be dimmed (or remain dim) and/or the user experience (UX) of the presently-displayed application (or operating system (OS) screen) on the device's display could remain unresponsive to user inputs. Upon determination of user attention, the UX can become responsive again and/or the display may be brightened. To conserve additional resources, the IMU and/or attention detection algorithm checks may be performed at some regular interval (e.g., 4 seconds) or irregular interval (e.g., after any time that the device or user moves more than a threshold amount), depending on the particular type of UX action involved. Once it has been detected that the user's attention of the electronic device's display has been lost, the display may again be auto-dimmed and/or the UX can stop being responsive to user input.

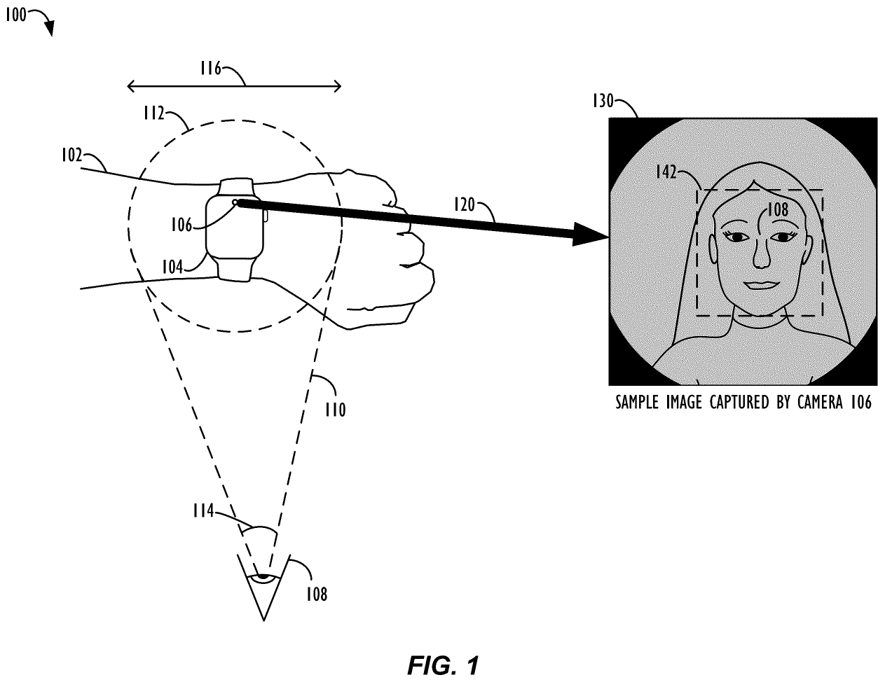

Determining User Attention based on Head/Gaze Pointing Direction Relative to a Display of an Electronic Device having Image Capture Capabilities Turning first to FIG. 1, an example 100 of an image 130 of a user 108 captured by an image capture device 106 of a wearable electronic device 104 is shown, according to one or more embodiments. In the example 100 of FIG. 1, the exemplary wearable electronic device 104 is a smartwatch, which is positioned on the arm 102 of a user/wearer 108 of the electronic device.

As shown in the top-down view of user 108 on the left-hand side of FIG. 1 (represented as an eye looking in the direction of user 108's head/gaze), the field of view (FOV) 110 of user 108's vision may also be represented by an angle 114. Thus, depending on the distance between user 108's head and the device 104, the region 112 in the environment in which it may be estimated or assumed that the user is currently looking at/paying attention to, may be represented by, in this example, circular region 112 having a diameter 116. As may be appreciated, the relative distances and sizes of the elements in FIG. 1 are shown merely for illustrative purposes.

As introduced above, according to some embodiments described herein, if an electronic device detects some predefined triggering event or action, e.g., a wake notification (such as an alert or timer), a display screen tap or other device UI button (e.g., physical or virtual button) interaction, moving the device into a particular pose, or showing audio playback controls on the device's display, etc., an attention awareness algorithm may be initiated. Once triggered, the device may use an IMU as a first pass to see if the device is also currently within a threshold range of a predetermined “attention-indicative” device pose (e.g., position and/or orientation), i.e., a device pose in which the user might wish to interact with the device's display (or other UI elements). For example, poses indicative of user attention may include: the device being in a raised position, a device display pointing upward and towards a user, a device being outside of a pocket and free from occlusion by any article of clothing, etc.

Once the device detects a triggering event and the device passes any initial pose thresholds, images may begin to be captured by a camera of the electronic device and may be fed to an attention detection algorithm (e.g., at regular or irregular intervals) to determine whether the user's head is (or remains) pointing in a direction relative to a display of the electronic device, wherein the attention awareness algorithm believes that the user likely desires to interact with the device's user interface (e.g., an estimated user head/gaze pointing direction falling within region 112, in the example of FIG. 1).

This determination of user attention may be helpful and/or improve overall efficiency of the system since, since, if a user is not even paying attention to a device at a given time, there is no need to perform further (and potentially more intensive) processing on images captured by the electronic device, screen brightening, and/or processing of user UI inputs.

In some embodiments, a UI indication or other alert may also be provided by the electronic device once user attention has been confirmed and the electronic device (and/or the app currently being displayed on the electronic device) will be entering an “attention aware” operational mode. For example, in some cases, the detection of user attention by a given app may cause the app to being performing an “auto-scrolling” operation on its content, to wake up the device display, to allow certain UI input that depend on detecting or recognizing a capture of the user's face, etc. In this way, the user will know that they can begin to control the device based on their attention (and, conversely, the UI indication/alert can be removed when the relative head/gaze pointing direction of the user is no longer indicative of the user paying attention to the electronic device's display).

As will be described in detail herein, according to some embodiments, in order to assist with the determination of whether the user's attention is presently on the electronic device's screen, one or more images may be obtained from an image capture device 106 integrated in the electronic device 104, e.g., at a regular or irregular interval, or in response to particular condition(s) sensed at the electronic device.

In the example of FIG. 1, image capture device 106 happens to be a camera that is co-aligned (i.e., pointed in the same direction as) the normal vector of the display screen of the electronic device 104. It is to be understood that, in other embodiments, the images captured by an image capture device integrated in the electronic device 104 may need to be rotated and/or translated before further analysis, i.e., so that their captured image data more accurately reflects the environment surrounding the electronic device that is directly aligned with the surface normal of the electronic device's display.

Following arrow 120, it may be seen that exemplary image 130 represents an image captured by integrated image capture device 106 that includes a representation of the user/wearer of the electronic device 108. According to some embodiments, the image capture device 106 can be monochrome, low resolution, and/or fisheye distorted, or have other characteristics that allow the camera to perform low power, wide FOV face detection. The image capture device can be wearable camera, a mobile device camera, or be another camera, e.g., a camera that is located elsewhere in the environment.

As illustrated in FIG. 1, according to some embodiments, heuristic-based and/or ML-based face detection algorithms may be applied to one or more of the images captured by image capture device 106. In some embodiments, the ML face detection models may preferably be lightweight enough to be able to run in a performant fashion on a wearable electronic device. In some such embodiments, a face detection box (e.g., face detection box 142) may be identified for one or more faces appearing in the captured images.

In some embodiments, if multiple faces are detected in a captured image, a rule or assumption may be applied to the captured image to make a determination as to which detected face is the user/wearer of the electronic device (e.g., the largest face, the closest face to the device, the most centered face, a face that is recognized as belonging to a user of the device, etc.). As may be understood, the device will preferably only attempt to track the head/face of the actual user/wearer of the electronic device (and not other people, e.g., who may be appearing in the background of images captured by the electronic device's integrated camera(s)).

In some such embodiments, a face detection algorithm/ML-based model may also return one or more coordinates and/or vectors that are estimated from the image data to represent the size, location, facial landmark features, facial expression, and/or pointing direction of a face detected in the captured image data.

### Using Head/gaze Pointing Direction As an Indicia of User Attention on a Display of a Wearable Electronic Device

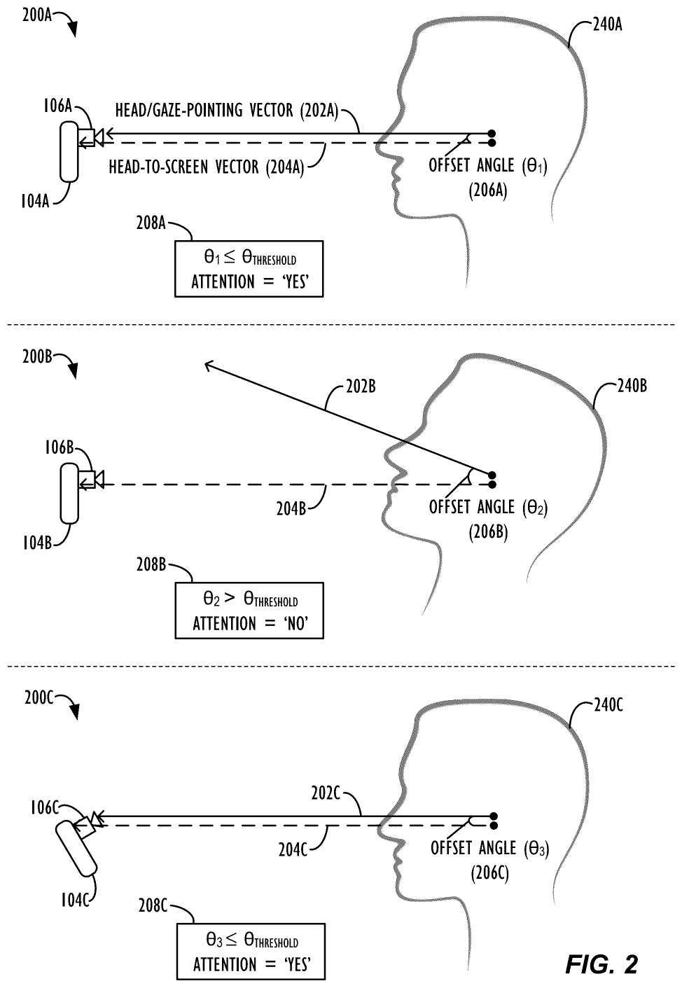

Turning now to FIG. 2, various examples 200 of using a user's head/gaze pointing direction relative to a display of a wearable electronic device as a signal indicative of user attention are illustrated, according to one or more embodiments. Some advantages of using user attention as a guide for device UI behavior include that: 1) it doesn't require the user's head to be pointing exactly aligned with a device's display; 2) it can reduce the amount of time (and/or number of times) that the device's display is turned on or brightened (and/or other processing is performed by the device), thereby saving device processing and power resources; and 3) it works more robustly—even without extensive calibration/user enrollment or high-quality captured images. As mentioned above, either one (or both) of head pointing direction and gaze pointing direction may be used as a proxy signal for estimating a direction of a user's attention. For example, in some implementations, head pointing direction may turn out to be a more reliable and robust predictor of the current direction of a user's attention, assuming such a signal is available.

Looking first at example 200A, based, e.g., on images of user 240A captured by camera 106A, electronic device 104A may determine that the user's head 240A is pointing in head/gaze pointing direction 202A. In this example, head/gaze pointing direction 202A happens to be aligned with a determined head-to-screen vector 204A. In other words, in example 200A, the user's head 240A is pointing in a direction 202A that has been determined to have an offset angle, θ₁ (206A), of essentially 0 degrees away from head-to-screen vector 204A. As shown in box 208A, the offset angle, θ₁ (206A), is less than or equal to a predetermined threshold offset angle (θ_{THRESHOLD}), which could be set at a threshold of, e.g., 15 degrees, 20 degrees, etc. Because the amount of angular distance between the head/gaze pointing direction 202A and head-to-screen vector 204A in the example 200A is less than the threshold offset angle (θ_{THRESHOLD}), the electronic device 104A can determine that user 240A is currently paying attention to the display screen of device 104A.

Looking next at example 200B, based, e.g., on images of user 240B captured by camera 106B, electronic device 104B may determine that the user's head 240B is pointing in head/gaze pointing direction 202B. In this example, head/gaze pointing direction 202B happens to be misaligned with a determined head-to-screen vector 204B. In other words, in example 200B, the user's head 240B is pointing in a direction 202B that has been determined to have an offset angle, θ₂ (206B), of approximately 30 degrees away from head-to-screen vector 204B. As shown in box 208B, the offset angle, θ₂ (206B), is greater than the predetermined threshold offset angle (θ_{THRESHOLD}). Because the amount of angular distance between the head/gaze pointing direction 202B and head-to-screen vector 204B in the example 200B is greater than the threshold offset angle (θ_{THRESHOLD}), the electronic device 104B can determine that user 240B is not currently paying attention to the display screen of device 104B. Thus, electronic device 104B could leave its display screen dimmed, or otherwise unresponsive, etc.

Looking next at example 200C, based, e.g., on images of user 240C captured by camera 106C, electronic device 104C may determine that the user's head 240C is pointing in head/gaze pointing direction 202C. In this example, despite the relative rotation of camera 106C (i.e., it is tilted upwards as compared to the pointing direction of camera 106A in example 200A), the relative alignment between the head/gaze pointing direction 202C and the determined head-to-screen vector 204C remains unchanged. In other words, in example 200C, the user's head 240C is pointing in a direction 202C that has been determined to have an offset angle, θ₃ (206C), of essentially 0 degrees away from head-to-screen vector 204C. As shown in box 208C, the offset angle, θ₃ (206C), is less than or equal to the predetermined threshold offset angle (θ_{THRESHOLD}). Because the amount of angular distance between the head/gaze pointing direction 202C and head-to-screen vector 204C in the example 200C is less than the threshold offset angle (θ_{THRESHOLD}), the electronic device 104C can determine that user 240C is still paying attention to the display screen of device 104C, i.e., despite the aforementioned rotation of camera 106C away from the user's head 240C.

### Using Head/Gaze Pointing Direction as an Indicia of User Attention on a Display of a Wearable Electronic Device having an Integrated Camera that is not Aligned with its Display

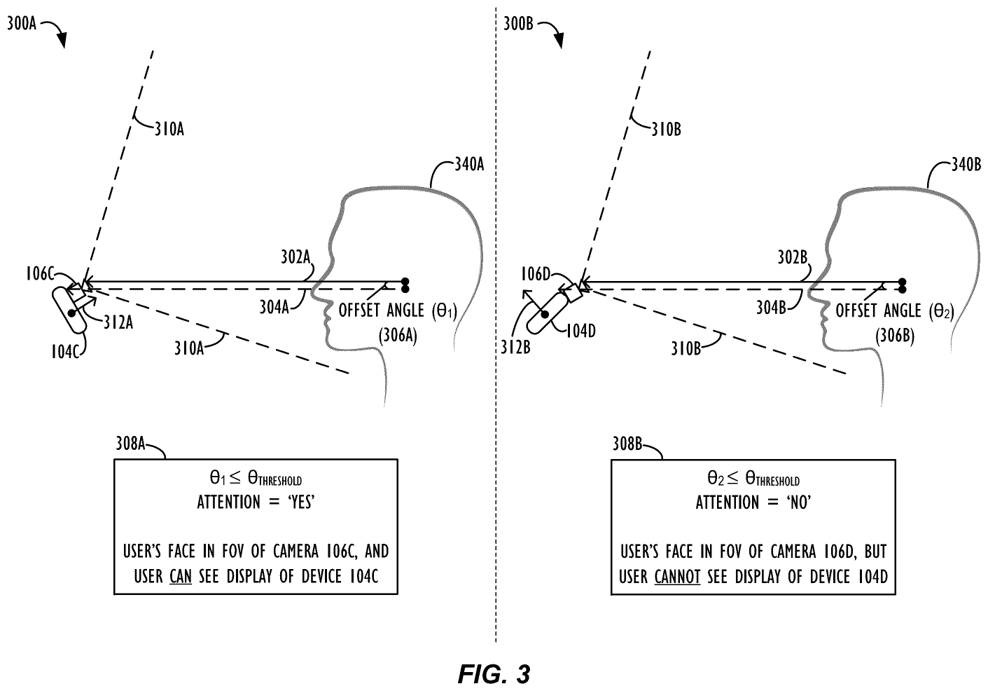

Turning now to FIG. 3, additional examples of using a user's head/gaze pointing direction relative to a display of a wearable electronic device as a signal indicative of user attention are illustrated, according to one or more embodiments. In particular, as will be described below, example 300B shows an example of an electronic device having an integrated camera that is not aligned with its display's normal vector 312B.

However, looking first at example 300A, based, e.g., on images of user 340A captured by camera 106C (which has a field of view 310A), electronic device 104C (which is the same electronic device and camera orientation illustrated in example 200C of FIG. 2, having a display normal vector 312A) may determine that the user's head 340A is pointing in head/gaze pointing direction 302A. In this example, head/gaze pointing direction 302A happens to be aligned with a determined head-to-screen vector 304A. In other words, in example 300A, the user's head 340A is pointing in a direction 302A that is still within the camera's FOV 310A and that has been determined to have an offset angle, θ₁ (306A), of essentially 0 degrees away from head-to-screen vector 304A. As shown in box 308A, the offset angle, θ₁ (306A), is less than or equal to a predetermined threshold offset angle (θ_{THRESHOLD}), which could be set at a threshold of, e.g., 5 degrees, 10 degrees, etc. Because the amount of angular distance between the head/gaze pointing direction 302A and head-to-screen vector 304A in the example 300A is less than the threshold offset angle (θ_{THRESHOLD}), the electronic device 104C can determine that user 340A can still see (and is currently paying attention to) the display screen of device 104C.

Turning now to the aforementioned example 300B, based, e.g., on images of user 340B captured by camera 106D (which has a field of view 310B), electronic device 104D (which is in an orientation where its display's normal vector 312B is essentially pointed away from the head of user 340B, even though the head of user 340B still appears in the FOV 310B of camera 106D) may determine that the user's head 340B is pointing in head/gaze pointing direction 302B. In this example, head/gaze pointing direction 302B is still aligned with a determined head-to-screen vector 304B. In other words, in example 300B, the user's head 340B is pointing in a direction 302B that is still within the camera's FOV 310B and that has been determined to have an offset angle, θ₂ (306B), of essentially 0 degrees away from head-to-screen vector 304B, but which does not fall within the predetermined threshold offset angle of the display's normal vector 312B, which is essentially pointed away from the head of user 340B.

Thus, as shown in box 308B, the offset angle, θ₂ (306B), is less than or equal to the predetermined threshold offset angle (θ_{THRESHOLD}), but it has been determined that the user cannot see the display of electronic device 104D, and, thus, there is no user attention on electronic device 104D.

In cases like example 300B, wherein the device's camera might still be able to detect the user's face, but the user is not able to see the device's display, e.g., because of how the camera is oriented with respect to the device's display, various approaches may be taken to attempt to determine whether the user is playing attention. In one approach, a 3D rotation may be applied to the camera's normal vector to attempt to align it with the display's normal (e.g., 312B) before the vector math is performed to see if the predetermined threshold offset angle has been exceeded. Alternatively, a shifted crop may be performed before any face detection or attention-based machine learning techniques are employed. Using this technique, the user's face will be automatically cropped out of the image if the user cannot currently see the electronic device's display, thereby indicating to the attention algorithm that it is not possible for the user to be presently paying attention to the electronic device's display.

It is to be understood that the examples 300A and 300B of FIG. 3 are merely illustrative examples of relative electronic device/integrated camera orientations and how such relative orientations may affect device determinations of user attention. Many other device/integrated camera orientations are possible, and they may greatly impact the range of angles and poses over which a user is still able to pay attention to the display of the electronic device.

### Exemplary Methods of Using a User's Head/Gaze Pointing Direction Relative to a Display of a Wearable Electronic Device as a Signal Indicative of User Attention

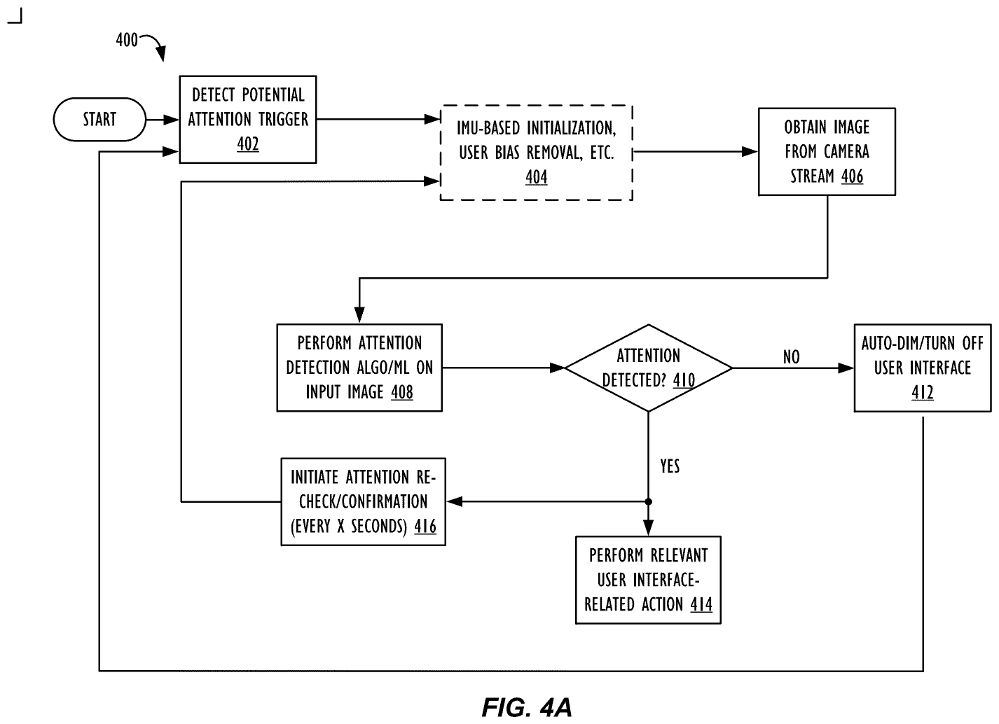

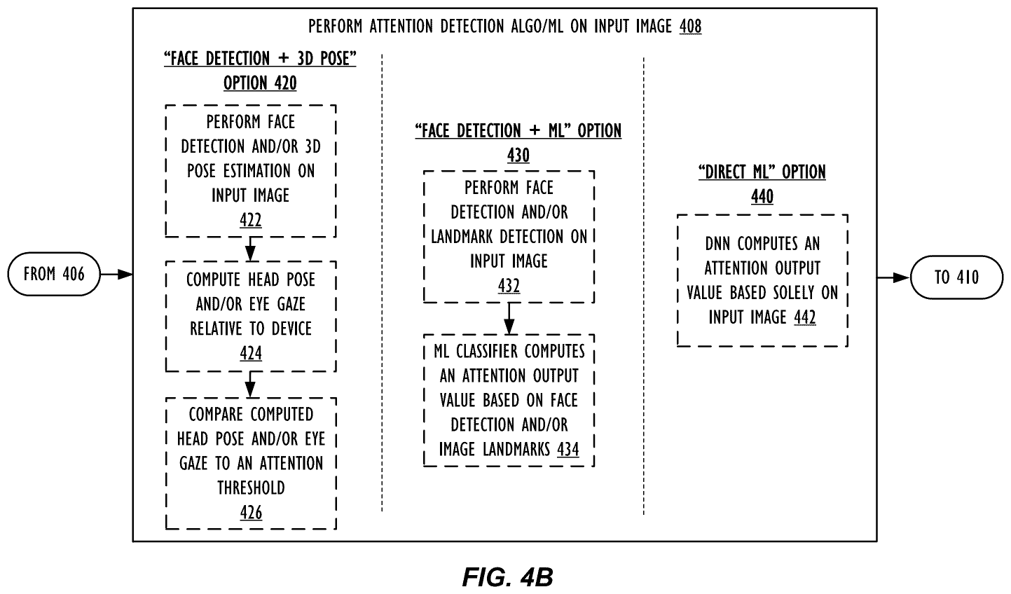

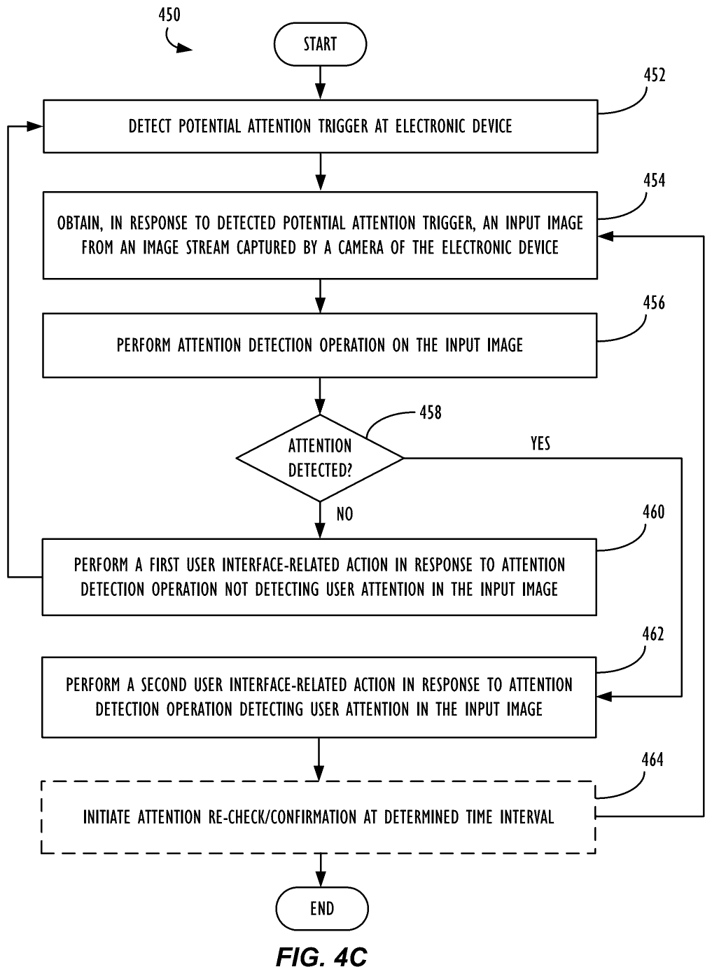

Turning first to FIG. 4A, a flow diagram illustrating a method 400 of using a user's head/gaze pointing direction relative to a display of a wearable electronic device as a signal indicative of user attention is shown, according to various embodiments. First, at Step 402, method 400 may detect a potential attention trigger. As described above, a trigger may be used to reduce power usage, e.g., so that an attention awareness algorithm is not continually running on the electronic device. Exemplary potential attention triggers may comprise at least one of the following: a notification, a device wake status, a user interface touch, or playing media content.

Next, at Step 404, method 400 may optionally perform one or more other operations to prepare the obtained images for further analysis. For example, user initialization and/or calibration operations may be performed to determine any preferences/characteristics of the user presently using the electronic device, address any user-specific variations (e.g., by comparing the user's perceived head/gaze pointing directions with ground truth/ML algorithm predictions and to identify any user-specific differences), and save any determined user-specific parameters related to head/gaze pointing direction for later use. In some embodiments, the electronic device may also learn and/or store different “neutral,” i.e., centered, head pointing directions for a given user, e.g., based on different device positions and orientations.

In some embodiments, a positional sensor, such as an inertial measurement unit (IMU), integrated within the electronic device may also be used to perform various tasks related to the user initialization and/or calibration operations. For example, an IMU may be used to: 1) define an initialization moment of a user's interaction with the device (e.g., determining whether the device has stopped moving while the user is paying attention to the device); 2) determine a neutral direction against which relative motion is calculated (e.g., the direction at the moment when the initialization is detected); and/or 3) estimate motion and adjust thresholds (e.g., to use bigger or smaller thresholds for detecting a significant motion).

Next, at Step 406, the method 400 may obtain one or more images streamed from a camera integrated in the electronic device (e.g., at a regular or irregular frame rate). According to some embodiments, one or more image pre-processing operations may optionally be applied to the images obtained at Step 406, e.g., image distortion correction, horizon leveling, scaling, etc., so as to place the obtained images in a form where the necessary information (e.g., face location, size, etc.) is most likely to be able to be gleaned or extracted from the obtained images using the preferred face detection algorithms or ML models.

Next, at Step 408, the method 400 may perform a desired attention detection algorithm and/or apply an ML-based attention model on an input image obtained at Step 406. Further details regarding various possible attention detection algorithms and techniques will be described in greater detail with reference to FIG. 4B, below.

Next, at Step 410 of method 400, may determine, e.g., based on the output of the Step 408 attention detection algorithm, whether or not the threshold for user attention has been met. If attention is not detected (i.e., “NO” at Step 410), the method 400 may proceed to Step 412 to take a desired user interface-related action in response to not detecting user attention, e.g., auto-dimming the electronic device's UX and/or turning off the electronic device's UI altogether, before returning to Step 402 to listen again for potential attention triggers.

If, instead, at Step 410 of method 400, it is determined, e.g., based on the output of the Step 408 attention detection algorithm, that the threshold for user attention has been met (i.e., “YES” at Step 410), the method 400 may proceed to Step 414 to take a desired user interface-related action in response to detecting user attention, e.g., auto-scrolling the electronic device's UX and/or turning on or brightening the electronic device's UI, etc., while also proceeding to Step 416 to re-initiate attention detection checks (e.g., by proceeding back to Step 404 or 406), e.g., at regular time intervals, i.e., to confirm that the user continues to pay attention to the display of the electronic device. Once it can no longer be confirmed that the user is paying attention to the electronic device, the method 400 will naturally reach Step 412, and then proceed as described above.

Turning next to FIG. 4B, a flow diagram illustrating exemplary algorithms 408 for detecting user attention relative to a display of a wearable electronic device using images captured by one or more integrated cameras of the electronic device are shown, according to various embodiments. As illustrated, FIG. 4B provides additional optional implementation details for the attention detection Step 408 from FIG. 4A.

In a first example, referred to herein as a “Face Detection +3D pose” option 420, the attention detection algorithm may proceed to Step 422, wherein the system performs face detection and/or 3D pose estimation on an input image obtained from the camera stream to identify a face of a user of the electronic device. Next, at Step 424 (and based on the output of Step 422), the option 420 may determine, based on the face detection operation, a current pose of the face (e.g., in terms of a head or gaze pointing direction) of the user relative to the electronic device, which may be achieved using typical CV/ML algorithms for providing head position and rotation.

Finally, at Step 426 (and based on the output of Step 424), the option 420 may compare the computed head pose and/or eye gaze direction relative to a device display normal vector to see if it exceeds an attention threshold. In one option, the angle between the head/gaze pointing vector and the head-to-screen vector may simply be compared against an angular threshold (e.g., 20 degrees) to determine whether the use is likely paying attention to the display of the electronic device. In another option, which will be described below at Step 434, a weighted average of head pose parameters, including head orientation (yaw, pitch, roll), head position, face landmark positions, angular offset between the head/gaze pointing vector and the head-to-screen vector, etc., may be used to calculate the value to compare against a threshold to determine user attention.

In some embodiments, performing option 420 may involve comparing various estimated vectors, as described above. In one such embodiment, Step 424 may involve first determining a vector aligned with the user's head pointing direction and/or gaze direction. In some such embodiments, user head pose and gaze may be determined relative to the electronic device's camera coordinate space, so that no tracking of the device itself is required. In other words, the electronic device estimates head pose and/or gaze direction relative to itself.

According to some such embodiments, as a first step in computing the user's head pose relative to the display of the electronic device, a dot product may be computed between the head pointing vector and the electronic device's display normal vector. If the dot product is 0, then the head pointing vector is perpendicular to the display normal vector, meaning it is parallel to the plane (i.e., at an extreme “glancing” angle). If the dot product has a value >0, the device's display plane is turned away from the user's head direction. In both such cases, it can be interpreted to mean that the user cannot see the device's display. (Note: If the device is rotated away from the user's face, the device's camera likely won't detect the user's face at all, so ray/vector math can be performed.) By contrast, when the dot product has a value <0, the algorithm may proceed to calculate the particular angle between the head pointing vector and the head-to-screen vector to determine if it is within the relevant angular threshold for a finding of attention.

In some implementations, a lookup table could be used to alter the vector or vector intersection point, such that additional enrollment/calibration of a user is not needed. The lookup table could be derived from, e.g.: user studies to determine common vectors for various head and IMU poses and/or learned from user behavior over time.

In a second example, referred to herein as a “Face Detection+Machine Learning (ML)” option 430, the attention detection algorithm may proceed to Step 432, wherein the system performs face detection and/or facial landmark detection on an input image obtained from the camera stream. Next, at Step 434 (and based on the output of Step 432), the option 430 may use a ML-based classifier, such as a linear regression model, to compute an attention output value based on the face detection and/or image landmarks detected at Step 432. For example, such an ML classifier may be able to produce one or more weighted parameters related to a detected face, such as a face size, face location, face normal vector, facial expression, etc. According to some implementations, weights for such parameters may be determined from a training process performed on a large dataset of relevant training data. The output of such an ML classifier may then be compared against an appropriate attention threshold to determine whether the user is likely to be currently paying attention to the display of the electronic device. It is to be understood that other ML classification algorithms could be used as well, i.e., as alternative to a linear regressor.

In a third example, referred to herein as a “Direct Machine Learning (ML)” option 440, the attention detection algorithm may proceed to Step 442, wherein the system uses a DNN to compute an attention output value based solely on the input image. For example, such a DNN may be able to produce an output parameter, e.g., a value between 0 . . . 1, that represents the confidence the DNN has that the analyzed image possesses a face that is paying attention to the camera that captured the image. By applying this output against an appropriate attention threshold, option 440 may determine whether the user is currently paying attention to the display of the electronic device.

Turning last to FIG. 4C, a flow diagram illustrating another method 450 of using a user's head/gaze pointing direction relative to a display of a wearable electronic device as a signal indicative of user attention is shown, according to various embodiments. First, at Step 452, the method 450 may detect a potential attention trigger at electronic device, various examples of which have been enumerated above.

Next, at Step 454, the method 450 may obtain, in response to detected potential attention trigger, an input image(s) from an image stream captured by a camera (or cameras) of the electronic device.

Next, at Step 456, the method 450 may perform an attention detection operation (e.g., any of the operations as described above, with reference to FIG. 4B) on the input image.

Next, at Step 458, the method 450 may make a determination, e.g., based on comparing the output of Step 456 to an appropriate attention threshold value, whether user attention is detected on the display of the electronic device. As may be understood, in some embodiments, a threshold may be employed to remove or reduce noise or fluctuations in the attention signal, thereby preventing the device from changing too rapidly into (or out of) a “user attention” mode and/or avoiding changing the status of the user attention mode when the user does not actually intend to begin paying attention (or stop paying attention) to the electronic device.

If user attention is detected (i.e., “YES” at Step 458), the method 450 may proceed to Step 462 and perform a second user interface-related action (e.g., a display screen auto-scrolling operation, a user interface navigation operation, or a user interface selection operation, a screen brightening operation, etc.) in response to attention detection operation detecting user attention in the input image. In this example, the first user interface-related action and the second user interface-related action are different, to illustrate the different behaviors the electronic device could undertake based on whether or not user attention is detected.

Next, the method 450 may optionally proceed to Step 464 and initiate an attention re-check/confirmation, e.g., at a determined time interval. As described above, re-checking for attention at a determined time interval (e.g., 1 second, 2 seconds, 4 seconds, etc.) allows the device to continue performing the second user interface-related action (which is potentially more power and/or processing resource intensive) only for roughly as long as the user is still paying attention to the device.

In other words, in response to the determined time interval elapsing since the performance of an initial attention detection operation (i.e., at Step 456), the process may return to Step 454 to obtain a subsequent input image and perform a subsequent attention detection operation (i.e., at Step 456 again), wherein the subsequent attention detection operation is based, at least in part, on the subsequent input image captured at Step 454. In response to the attention detection operation determining that user attention is no longer detected, the electronic device will cease performance of the second user interface-related action (and may, instead, perform the first user interface-related action at Step 460 again).

As may now be appreciated, calibrating the determined time interval at Step 464 correctly can strike a desired balance between perceived responsiveness of the electronic device to the user's detention and the conservation of device power and processing resources.

If, instead, user attention is not detected (i.e., “NO” at Step 458), the method 450 may proceed to Step 460 and perform a first user interface-related action (e.g., stop an auto-scrolling operation, a display dimming operation, a display deactivation operation, or entering a low-power state etc.) in response to attention detection operation not detecting user attention in the input image. Next, the method 450 may return back to Step 452 to listen for more potential attention triggers at the electronic device.

The various methods described herein, e.g., with reference to FIG. 4A-4C, may be performed by an electronic device, e.g., via being initiated by an application (or “App”) executing on the device and/or the device's native operating system (OS). For example, an App executing on the device could initiate or implement all of the steps in a method, or at least a portion of the steps in the method, while making calls to the device's OS to perform other steps in the method. Similarly, a device's OS can receive API calls from an App or elsewhere and process/perform the calls to cause the method to be performed by the device(s).

In some implementations, one or more of the processing steps may also be performed by a device that is remote to the electronic device, e.g., on a smartphone, laptop or other electronic device associated with the user, and/or on a server device accessible to the electronic device via a network connection (which server device may, e.g., have greater processing capacity than a wearable electronic device).

### Exemplary Electronic Computing Devices

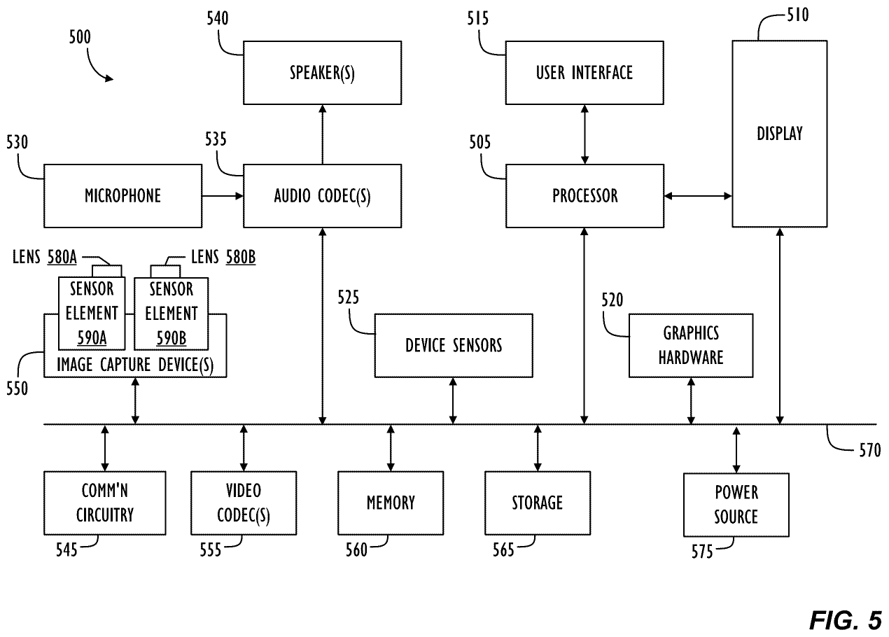

Referring now to FIG. 5, a simplified functional block diagram of illustrative programmable electronic computing device 500 is shown according to one embodiment. Electronic device 500 could be, for example, a mobile telephone, personal media device, portable camera, or a tablet, notebook or desktop computer system. As shown, electronic device 500 may include processor 505, display 510, user interface 515, graphics hardware 520, device sensors 525 (e.g., proximity sensor/ambient light sensor, accelerometer, inertial measurement unit, and/or gyroscope), microphone 530, audio codec(s) 535, speaker(s) 540, communications circuitry 545, image capture device 550, which may, e.g., comprise multiple camera units/optical image sensors having different characteristics or abilities (e.g., Still Image Stabilization (SIS), HDR, OIS systems, optical zoom, digital zoom, etc.), video codec(s) 555, memory 560, storage 565, and communications bus 570.

Processor 505 may execute instructions necessary to carry out or control the operation of many functions performed by electronic device 500 (e.g., such as the generation, processing, and/or streaming of images and video data in accordance with the various embodiments described herein). Processor 505 may, for instance, drive display 510 and receive user input from user interface 515. User interface 515 can take a variety of forms, such as a button, keypad, dial, a click wheel, keyboard, display screen and/or a touch screen. User interface 515 could, for example, be the conduit through which a user may view a captured video stream and/or indicate particular image frame(s) that the user would like to capture (e.g., by clicking on a physical or virtual button at the moment the desired image frame is being displayed on the device's display screen). In one embodiment, display 510 may display a video stream as it is captured while processor 505 and/or graphics hardware 520 and/or image capture circuitry contemporaneously generate and store the video stream in memory 560 and/or storage 565. Processor 505 may be a system-on-chip (SOC) such as those found in mobile devices and include one or more dedicated graphics processing units (GPUs). Processor 505 may be based on reduced instruction-set computer (RISC) or complex instruction-set computer (CISC) architectures or any other suitable architecture and may include one or more processing cores. Graphics hardware 520 may be special purpose computational hardware for processing graphics and/or assisting processor 505 perform computational tasks. In one embodiment, graphics hardware 520 may include one or more programmable graphics processing units (GPUs) and/or one or more specialized SOCs, e.g., an SOC specially designed to implement neural network and machine learning operations (e.g., convolutions) in a more energy-efficient manner than either the main device central processing unit (CPU) or a typical GPU, such as Apple's Neural Engine processing cores.

Image capture device 550 may comprise one or more camera units configured to capture images, e.g., images which may be processed to generate cropped, augmented, and/or distortion-corrected versions of said captured images, e.g., in accordance with this disclosure. Image capture device(s) 550 may include two (or more) lens assemblies 580A and 580B, where each lens assembly may have a separate focal length. For example, lens assembly 580A may have a shorter focal length relative to the focal length of lens assembly 580B. Each lens assembly may have a separate associated sensor element, e.g., sensor elements 590A/590B. Alternatively, two or more lens assemblies may share a common sensor element. Image capture device(s) 550 may capture still and/or video images. Output from image capture device 550 may be processed, at least in part, by video codec(s) 555 and/or processor 505 and/or graphics hardware 520, and/or a dedicated image processing unit or image signal processor incorporated within image capture device 550. Images so captured may be stored in memory 560 and/or storage 565.

Memory 560 may include one or more different types of media used by processor 505, graphics hardware 520, and image capture device 550 to perform device functions. For example, memory 560 may include memory cache, read-only memory (ROM), and/or random access memory (RAM). Storage 565 may store media (e.g., audio, image and video files), computer program instructions or software, preference information, device profile information, and any other suitable data. Storage 565 may include one more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 560 and storage 565 may be used to retain computer program instructions or code organized into one or more modules and written in any desired computer programming language. When executed by, for example, processor 505, such computer program code may implement one or more of the methods or processes described herein. Power source 575 may comprise a rechargeable battery (e.g., a lithium-ion battery, or the like) or other electrical connection to a power supply, e.g., to a mains power source, that is used to manage and/or provide electrical power to the electronic components and associated circuitry of electronic device 500.

It is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled.

What is claimed is:

1. A method comprising:
detecting, at an electronic device, a potential attention trigger;
obtaining, in response to the detected potential attention trigger, at least a first input image captured at a first time by a camera of the electronic device;
performing a first attention detection operation based, at least in part, on the first input image;
performing, in response to the first attention detection operation determining that user attention is not detected, a first user interface-related action on the electronic device; and
performing, in response to the first attention detection operation determining that user attention is detected, a second user interface-related action on the electronic device.

2. The method of claim 1, wherein the electronic device comprises a wearable device.

3. The method of claim 2, wherein the wearable device comprises a smartwatch.

4. The method of claim 1, wherein the potential attention trigger comprises detecting at least one of the following: a notification, a device wake status, a user interface touch, or playing media content.

5. The method of claim 1, further comprising:
confirming, in response to the detected potential action trigger, that a current pose of the electronic device is within a threshold difference of a predetermined pose.

6. The method of claim 5, wherein confirming, in response to the detected potential action trigger, that a current pose of the electronic device is within a threshold difference of a predetermined pose further comprises:
obtaining positional data from an inertial measurement unit (IMU) of the electronic device.

7. The method of claim 1, wherein performing a first attention detection operation on the first input image further comprises:
performing a face detection operation on the first input image to identify a face of a user of the electronic device;
determining, based on the face detection operation, a current pose of the face of the user relative to the electronic device; and
detecting user attention based, at least in part, on applying a pose threshold to the determined current pose of the face of the user.

8. The method of claim 1, wherein performing a first attention detection operation on the first input image further comprises:
performing a face detection operation on the first input image to identify a face of a user of the electronic device;
determining, based on the face detection operation, a current gaze direction of the user relative to the electronic device; and
detecting user attention based, at least in part, on applying a gaze direction threshold to the determined current gaze direction of the user.

9. The method of claim 1, wherein performing a first attention detection operation on the first input image further comprises:
performing a face detection operation on the first input image to identify a face of a user of the electronic device;
determining, based on the face detection operation, one or more image landmarks in the first input image; and
detecting user attention based, at least in part, on applying a machine learning (ML) classifier to the determined one or more image landmarks in the first input image.

10. The method of claim 1, wherein performing a first attention detection operation on the first input image further comprises:
detecting user attention based, at least in part, on applying a deep neural network (DNN) to the first input image.

11. The method of claim 1, wherein the first attention detection operation outputs a value, and wherein the first attention detection operation determining that user attention is detected comprises determining that the value output from the first attention detection operation is greater than or equal to an attention threshold value.

12. The method of claim 1, wherein the first user interface-related action performed on the electronic device comprises at least one of: a display dimming operation, a display deactivation operation, or entering a low-power state.

13. The method of claim 1, wherein the second user interface-related action performed on the electronic device comprises at least one of: a display screen auto-scrolling operation, a user interface navigation operation, or a user interface selection operation.

14. The method of claim 1, further comprising:
performing, in response to a determined time interval elapsing since the performance of the first attention detection operation, a second attention detection operation,
wherein the second attention detection operation is based, at least in part, on a second input image captured at a second time by the camera of the electronic device.

15. The method of claim 14, further comprising:
ceasing, in response to the second attention detection operation determining that user attention is not detected, performance of the second user interface-related action on the electronic device.

16. The method of claim 1, wherein the first user interface-related action and the second user interface-related action are different.

17. A non-transitory computer readable medium comprising computer readable code executable by one or more processors to:
detect, at an electronic device, a potential attention trigger;
obtain, in response to the detected potential attention trigger, at least a first input image captured at a first time by a camera of the electronic device;
perform a first attention detection operation based, at least in part, on the first input image;
perform, in response to the first attention detection operation determining that user attention is not detected, a first user interface-related action on the electronic device; and
perform, in response to the first attention detection operation determining that user attention is detected, a second user interface-related action on the electronic device.

18. The non-transitory computer readable medium of claim 17, wherein the computer readable code is further executable by one or more processors to:
perform, in response to a determined time interval elapsing since the performance of the first attention detection operation, a second attention detection operation,
wherein the second attention detection operation is based, at least in part, on a second input image captured at a second time by the camera of the electronic device.

19. The non-transitory computer readable medium of claim 18, wherein the computer readable code is further executable by one or more processors to:
cease, in response to the second attention detection operation determining that user attention is not detected, performance of the second user interface-related action on the electronic device.

20. A wearable electronic device comprising:
one or more processors;
a user interface;
one or more cameras; and
one or more computer readable media comprising computer readable code executable by the one or more processors to:
detect a potential attention trigger;
obtain, in response to the detected potential attention trigger, at least a first input image captured at a first time by a camera of the one or more cameras;
perform a first attention detection operation based, at least in part, on the first input image;
perform, in response to the first attention detection operation determining that user attention is not detected, a first user interface-related action on the wearable electronic device; and
perform, in response to the first attention detection operation determining that user attention is detected, a second user interface-related action on the wearable electronic device,
wherein the first user interface-related action and the second user interface-related action are different.
